(19) United States
(12) Patent Application Publication
(10) Pub. No.: US 2024/0177062 A1
(43) Pub. Date: May 30, 2024

(54) LEARNING DATA GENERATION METHOD, LEARNING DATA GENERATION SYSTEM, AND COUNTERFEIT DETECTION SYSTEM

(71) Applicant: Samsung Electronics Co., Ltd., Suwon-si (KR)

(72) Inventors: Moonkyu SONG, Suwon-si (KR); Hanju JE, Suwon-si (KR); Yongjoo KWON, Suwon-si (KR); Joohwan KIM, Suwon-si (KR); Junseo LEE, Suwon-si (KR)

(73) Assignee: Samsung Electronics Co., Ltd., Suwon-si (KR)

(21) Appl. No.: 18/468,351

(22) Filed: Sep. 15, 2023

(30) Foreign Application Priority Data
Nov. 29, 2022 (KR) 10-2022-0163419

(51) Int. Cl. G06N 20/00

(52) U.S. Cl. CPC G06N 20/00

(57) ABSTRACT

Provided is a learning data generation method including selecting first data and second data, each of the first data and the second data having a similarity to registered biometric data that is greater than or equal to a first threshold, determining a matching degree between the first data and the second data, and generating learning data based on matching the first data to the second data in response to a determination that the matching degree is greater than or equal to a second threshold.

### CROSS-REFERENCE TO RELATED APPLICATION

This application is based on and claims priority under 35 U.S.C. § 119 to Korean Patent Application No. 10-2022-0163419, filed on Nov. 29, 2022, in the Korean Intellectual Property Office, the disclosure of which is incorporated by reference herein in its entirety.

### BACKGROUND

The inventive concepts relate to learning data generation methods, learning data generation systems, and counterfeit detection systems.

In personal authentication of an electronic device, it is becoming common to use biometric information of a user having excellent invariability and uniqueness. Among the uses of biometric information, fingerprint recognition has become the most popular authentication method compared to other methods because of its simple implementation method and excellent identification.

Optical fingerprint recognition is a method of acquiring a fingerprint image based on light reflected by a fingerprint of a finger. Recently, a spoofing attack in which a user's fingerprint is forged has been increasing, and a preventive measure for preventing this is required.

### SUMMARY

Some example embodiments of the inventive concepts provide a method of generating data having a high degree of similarity and matching to respond to a spoofing attack.

A learning data generation method according to the technical idea of the inventive concepts for achieving the above technical problem is disclosed.

According to some example embodiments of the inventive concepts, a learning data generation method may include selecting first data and second data, each of the first data and the second data having a similarity to registered biometric data that is greater than or equal to a first threshold; determining a matching degree between the first data and the second data; and generating learning data based on matching the first data to the second data in response to a determination that the matching degree is greater than or equal to a second threshold.

A counterfeit detection system according to the technical idea of the inventive concepts for achieving the above technical problem is disclosed.

According to some example embodiments of the inventive concepts, a counterfeit detection system may include a learning data generation unit configured to generate learning data obtained by matching first data and second data, a learning unit configured to learn content through the learning data generated by the learning data generation unit, an input unit configured to receive biometric data, and a determination unit configured to determine whether the biometric data is normal data or forged data based on the content learned in the learning unit, wherein the learning data includes data indicating a similarity degree with the normal data and a matching degree between the first data and the second data.

A learning data generation system according to the technical idea of the inventive concepts for achieving the above technical problem is disclosed.

According to some example embodiments of the inventive concepts, a system for generating learning data for learning counterfeit data for attacking registered biometric data may include at least one database including a first group including information of the registered biometric data but not body information, a second group including body information and not including information of the registered biometric data. The system may further include a learning data matching unit configured to generate the learning data based on matching at least one piece of data from the first group to at least one piece of data from the second group.

### BRIEF DESCRIPTION OF THE DRAWINGS

Some example embodiments will be more clearly understood from the following detailed description taken in conjunction with the accompanying drawings in which:

FIG. 1 is a block diagram of a counterfeit detection system according to some example embodiments;

FIG. 2 is a block diagram of a learning data generation system according to some example embodiments;

FIG. 3 is a diagram for explaining a process of generating learning data according to some example embodiments;

FIG. 4 is some example embodiments of learning data generated according to some example embodiments;

FIG. 5 is a flowchart illustrating a method of generating learning data, according to some example embodiments;

FIG. 6 is a flowchart illustrating a method of generating learning data, according to some example embodiments;

FIG. 7 is a flowchart illustrating a matching degree determination method according to some example embodiments; and

FIG. 8 is a block diagram of a learning data generation system according to some example embodiments.

### DETAILED DESCRIPTION

Hereinafter, some example embodiments of the inventive concepts will be described with reference to the accompanying drawings.

As described herein, when an operation is described to be performed, or an effect such as a structure is described to be established “by” or “through” performing additional operations, it will be understood that the operation may be performed and/or the effect/structure may be established “based on” the additional operations, which may include performing said additional operations alone or in combination with other further additional operations.

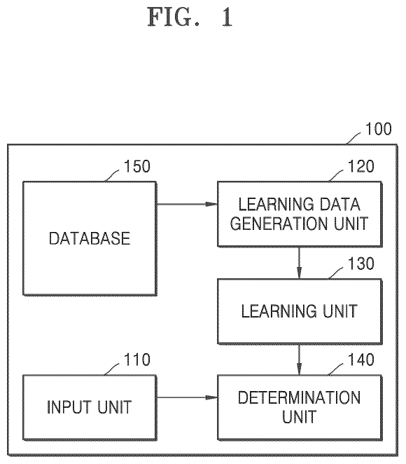

FIG. 1 is a block diagram of a counterfeit detection system according to some example embodiments. According to the inventive concepts, to increase the security of an authentication method using biometric information, a data augmentation method capable of determining the degree of matching between a plurality of pieces of data and improving the degree of matching and a counterfeit detection system 100 using the same are proposed.

The counterfeit detection system 100 according to the inventive concepts may include an input unit 110, a learning data generation unit 120, a learning unit 130, a determination unit 140, and a database 150.

The input unit 110 may convert biometric information of a user received through a camera or various sensors into data. The input unit 110 may include at least one of a key input unit, such as a keyboard or keypad, a touch input unit, such as a touch sensor or touch pad, a sound source input unit, a camera, or various sensors, and may include a gesture input unit. In addition, the input unit 110 may include any type of input units that are currently under development or are to be developed in the future.

The input unit 110 may receive input data including biometric information, which is a target of counterfeit determination. Biometric information may be referred to herein interchangeably as biometric data. Biometric information may, in some example embodiments, be referred to as biometric information associated with a particular user. Hereinafter, for convenience of explanation, it is assumed that biometric information of a user input is a fingerprint (e.g., an image of a human fingerprint). However, some example embodiments may be equally applied to a variety of biometric information recognizable as images, such as veins and irises (e.g., an image of a human vein, an image of a human iris, etc.). In some example embodiments, the input unit 110 may include an image sensor configured to generate a fingerprint image based on a fingerprint being applied to a surface of the input unit 110. In some example embodiments, the input unit 110 may include a temperature sensor, humidity sensor, or the like that is configured to generate temperature data and/or humidity data that is included as metadata of the biometric information of the fingerprint image, based on the fingerprint being applied to the surface of the input unit 110.

According to some example embodiments, the input unit 110 may include a sensor. According to some example embodiments, the sensor may detect a user's fingerprint information (e.g., generate an image of a fingerprint associated with a particular user). For example, a sensor may include a plurality of sensing elements. A plurality of sensing elements may be arranged in an array or matrix structure. The sensor may detect a fingerprint input (e.g., fingerprint interaction with the sensor) in the form of an analog signal using a plurality of sensing elements. The sensor may convert a sensed analog signal into a digital image (e.g., a digital image of the fingerprint) using an analog-to-digital converter.

The learning data generation unit 120 may generate learning data by (e.g., based on) matching two or more pieces of data. According to some example embodiments, the learning data generation unit 120 may generate learning data by matching first data and second data having different characteristics. According to some example embodiments, the learning data generation unit 120 may match forged biometric information having body characteristics (e.g., a forged fingerprint image having body characteristics) to the same or different biometric information having forged characteristics (e.g., a forged fingerprint image having forged characteristics). According to some example embodiments, the first data may be forged biometric information having body characteristics (also referred to herein interchangeably as physical information, physical characteristics, or the like). According to some example embodiments, the second data may be the same or different biometric information (e.g., the forged biometric information) having forged characteristics, such as non-physical characteristics (also referred to herein interchangeably as non-physical information, non-physical characteristics, or the like). In the inventive concepts, normal biometric data including normal body information of a specific user (e.g., registered biometric data including body characteristics of a registered user) may be used interchangeably with the terms of normal data, normal information, registered biometric information, or registered biometric data. In the inventive concepts, normal data may refer to data including both biometric information (e.g., a fingerprint image) and body characteristics of a user (e.g., associated with a particular user). The first data and the second data may be data having only one of the user's biometric information and body characteristics. For example, forged biometric information may be data having biometric information that is different from biometric data of the specific user, but including body characteristics.

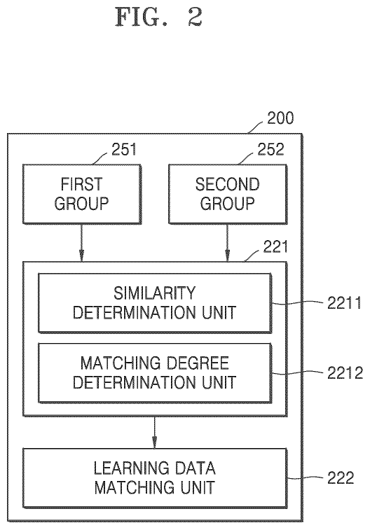

To generate matching data with a high degree of similarity and matching, the learning data generation unit 120 may search for data similar to the registered biometric data and change a variable related to the matching degree to generate matching data having the maximum matching degree. This is described below in detail with respect to FIG. 2.

The learning unit 130 may include a hardware structure specialized for processing (e.g., configured to implement, generate, create, etc.) an artificial intelligence model. Artificial intelligence models may be created through machine learning, for example using a learning algorithm. For example, the learning unit 130 may apply learning algorithm to learning data that is generated by the learning data generation unit 120 to create an output algorithm, for example an artificial intelligence model, that indicates whether an input biometric data is “normal data” (e.g., registered biometric data) or “forged data”. Such learning may be performed, for example, in the counterfeit detection system 100 itself in which an artificial intelligence model is performed, or may be performed through a separate server (not shown). The learning algorithm may include, for example, supervised learning, unsupervised learning, semi-supervised learning, or reinforcement learning, but is not limited to the above examples. The artificial intelligence model may include a plurality of artificial neural network layers.

As an example, the learning unit 130 may implement an artificial neural network that is trained on learning data generated by the learning data generation unit 120 as a set of training data by, for example, a supervised, unsupervised, and/or reinforcement learning model, and wherein the learning unit 130 may process a feature vector to provide output based upon the training.

Artificial neural networks may be one of a deep neural network (DNN), a convolutional neural network (CNN), a recurrent neural network (RNN), a restricted Boltzmann machine (RBM), a deep belief network (DBN), a bidirectional recurrent deep neural network (BRDNN), a deep Q-network, or a combination of two or more of the above, but are not limited to the above examples. The artificial intelligence model may include, in addition or alternatively, software structures in addition to hardware structures. Alternatively or additionally, the learning unit 130 may implement other forms of artificial intelligence and/or machine learning based on the learning data, such as, for example, linear and/or logistic regression, statistical clustering, Bayesian classification, decision trees, dimensionality reduction such as principal component analysis, and expert systems; and/or combinations thereof, including ensembles such as random forests. Herein, an artificial neural network may have any structure that is trainable, e.g., with learning data that is used as training data.

The learning unit 130 may perform learning (e.g., learn content, generate learned content, etc.) using data (e.g., learning data) generated by the learning data generation unit 120 through the artificial neural network. Such learning (e.g., the learned content) may include an algorithm having an output indicating whether an input biometric data is “normal data” (e.g., registered biometric data, identifying that the biometric data is provided by a registered, or authorized, user) or “forged data.” The algorithm may be applied by the determination unit 140 to input biometric data received from the input unit 110 to determine whether the input biometric data is normal data or forged data. Based on such determination, the determination unit 140 may be configured to selectively enable functionality of a device, selectively grant user access to functionality of a device, or the like. Through this, the performance of the counterfeit detection system 100 (e.g., to selectively block user access, device functionality or the like based on determining that the input biometric data is forged) may be further improved, thereby improving security provided by the determination unit 140.

The determination unit 140 may determine whether input data that is input (e.g., received) through the input unit 110 is forged data. The determination unit 140 may determine whether or not the data is fake (e.g., forged) based on the data learned through the learning unit 130 (e.g., an algorithm generated by the learning unit 130 based on the learning data generated by the learning data generation unit 120). According to the inventive concepts, since the learning unit 130 performs learning through data having a high degree of similarity and matching, the discrimination performance of the determination unit 140 may be improved compared to the existing one, and it is possible to easily determine whether fake data exists. The determination unit 140 may be configured to control an electronic device to selectively enable or block user access to one or more functions of the electronic device based on a determination of whether the input data is forged or not forged. Accordingly, based on the performance of the counterfeit detection system 100 being improved based on the determination unit 140 determining whether or not the data is fake (e.g., forged) based on the data learned through the learning unit 130, security of access to the electronic device may be improved based on enabling the determination unit to selectively prevent user access via forged input data with improved reliability.

The database 150 may be a storage space for storing first data and second data, that is, matching targets, in the learning data generation unit 120. The database 150 may include both data including physical information and data not including physical information. The database 150 may include data for learning in the learning data generation unit 120 and registered biometric data. The database 150 may include data identical to registered biometric data and data that does not match the registered biometric data. The database 150 may include pieces of data that are candidates for matching. Data stored in the database 150 may be data input through the input unit 110 or may be data transmitted through a separate server (not shown). According to some example embodiments, the database 150 may include memory. According to some example embodiments, the database 150 may include volatile memory or non-volatile memory. The database 150 may be implemented by a memory device, for example a solid state drive (SSD) memory device.

The counterfeit detection system 100 according to the inventive concepts may generate matching data to respond to an attack using data matching and learn using such data. To respond to a high attack level, the counterfeit detection system 100 according to the inventive concepts may search for biometric information having a high degree of similarity and matching by using various types of information, and perform matching on the found biometric information. According to the inventive concepts, images generated through matching may be collected as data and used for learning of a CNN. According to the inventive concepts, the performance of a counterfeit detection system may be improved by using a CNN using the generated image.

FIG. 2 is a block diagram of a learning data generation system according to some example embodiments.

When using a system, such as making a payment using the user's biometric information, there is a possibility of being attacked by stealing the user's biometric information and inputting forged biometric information. However, counterfeit biometric information may be easily defended against because the counterfeit biometric information does not have the characteristics of the body. For example, biometric information provided by a live human body and received at the input unit may have different characteristics from biometric information not provided by a live human body, such as different (e.g., greater or less) resolution of a given fingerprint pattern and/or ridges thereof displayed in the fingerprint image, different size and/or thickness of individual ridges of the fingerprint pattern displayed in the fingerprint image, different temperature detected by the input unit 110, different humidity detected by the input unit 110, or the like. Therefore, the attack method evolves and there is a possibility of being attacked by synthesizing fake information having a user's own biometric information and information having body characteristics but not having a user's own biometric information. That is, since it is difficult to generate information that has user information (e.g., a fingerprint image) and body characteristics (e.g., temperature data corresponding to a finger of a live human body, size and/or thickness and/or resolution of individual fingerprint ridges of the fingerprint pattern displayed in the fingerprint image), an attack may be made by combining forged information that has user information with information that has body characteristics with non-user information. For example, information that includes a fingerprint image that does not match, but may be similar to, the fingerprint image of a registered user and further has characteristics associated with the fingerprint image being provided by a live human body, such as temperature data included as metadata or as part of the fingerprint image, resolution and/or thickness and/or size of individual ridges of the fingerprint pattern displayed in the fingerprint image that correspond to the fingerprint image being generated based on applying a live human body finger to an input unit, may be combined with separate information that includes a fingerprint image that matches or is similar to the fingerprint image of a registered user and further has characteristics associated with the fingerprint image being provided by a structure that is not a live human body, such as temperature data included as metadata or as part of the fingerprint image, resolution and/or thickness and/or size of individual ridges of the fingerprint pattern displayed in the fingerprint image that correspond to the fingerprint image being generated based on applying a structure that is not a live human body finger to an input unit. At this time, various synthesis methods may be used, but a simple physical matching method may be simple and easy to attack to input information. If a simple physical matching method is used, mismatching may occur due to discontinuity between user information and non-user information, and mismatching may occur due to discontinuity between fake information and body characteristics. To mitigate the mismatching, mismatching information with a small degree of discontinuity among the unique biometric information of various non-users should be used. Therefore, the learning data generation system 200 according to the inventive concepts may increase counterfeit discrimination performance by generating matching data with mismatching alleviated and performing learning (e.g., by the learning unit 130) through the matching data.

The learning data generation system 200 according to the inventive concepts may include a first group 251, a second group 252, a data determination unit 221, and a learning data matching unit 222. The data determination unit 221 may include a similarity determination unit 2211 and a matching degree determination unit 2212. According to some example embodiments, the first group 251 and the second group 252 of FIG. 2 may correspond to the database 150 of FIG. 1. Restated, the database 150 of FIG. 1 may include the first group 251 and the second group 252 of FIG. 2. According to some example embodiments, the data determination unit 221 and the learning data matching unit 222 of FIG. 2 may correspond to (e.g., may be implemented by) the learning data generation unit 120 of FIG. 1. In the description of FIG. 2, descriptions that are substantially the same as the description of FIG. 1 are omitted.

According to some example embodiments, the first data included in the first group 251 may be data including non-physical characteristics while including registered biometric data. According to some example embodiments, the non-physical characteristics may be characteristics of fake materials (e.g., materials not included as part of a live human body) made of various materials. According to some example embodiments, the first data may be data in which information of registered biometric data is mixed with non-physical features, such as silicon, tape, rubber, and the like. According to another example, the first data included in the first group 251 may be data including non-physical characteristics and information (e.g., biometric information) having a high similarity to registered biometric data. For example, the first data may include a fingerprint image that matches a registered fingerprint image of a registered biometric data and may include additional information corresponding to the fingerprint image being generated based on an inorganic material (e.g., an aluminum structure, silicon structure, tape structure, rubber structure, or the like) applying the imaged fingerprint to be detected by an input unit 110. Such additional information may be metadata included in the first data, such as temperature, humidity, or the like that may be detected by an input unit 110 based on the fingerprint being applied to be detected by the input unit 110, where such temperature and/or humidity data indicates that the fingerprint is applied by a structure that is not a live human body (e.g., the temperature and humidity do not match and/or are outside a certain margin (e.g., 10% margin) from a range of known body temperature and humidity values of a live human body finger). Such additional information may be the resolution and/or thickness and/or size of individual ridges of the fingerprint pattern displayed in the fingerprint image that correspond to the fingerprint image being generated based on applying a structure that is not a live human body finger (e.g., an aluminum structure, silicon structure, tape structure, rubber structure, or the like) to an input unit 110 to cause the input unit 110 to generate the fingerprint image. Data including information having a high similarity to the registered biometric data may refer to data similar to the registered biometric data up to about 3% of the top (e.g., data having about 97% to 100% similarity to the registered biometric data).

According to some example embodiments, the second data included in the second group 252 may be data that does not match registered biometric data and includes physical characteristics. According to some example embodiments, the data included in the second group 252 may be a real fingerprint of another user other than the registered user's fingerprint, that is, another person's fingerprint data including physical information. For example, the second data may include a fingerprint image that does not match a registered fingerprint image of a registered biometric data and may include additional information corresponding to the fingerprint image being generated based on a finger of a live human body applying the imaged fingerprint to be detected by an input unit 110. Such additional information may be metadata included in the second data, such as temperature, humidity, or the like that may be detected by an input unit 110 based on the fingerprint being applied to be detected by the input unit 110, where such temperature and/or humidity data indicates that the fingerprint is applied by a live human body (e.g., the temperature and humidity match and/or are within a certain margin (e.g., 10% margin) from a range of known body temperature and humidity values of a live human body finger). Such additional information may be the resolution and/or thickness and/or size of individual ridges of the fingerprint pattern displayed in the fingerprint image that correspond to the fingerprint image being generated based on applying a live human body finger to an input unit 110 to cause the input unit 110 to generate the fingerprint image.

Such data may be extracted from an image input by the input unit 110 (see FIG. 1) or may be data received from an external server (not shown). According to some example embodiments, such data may be classified into a first group 251 or a second group 252 according to characteristics of the data. According to some example embodiments, data including physical characteristics may be classified as a second group 252, and data not including physical characteristics may be classified as a first group 251.

The similarity determination unit 2211 may determine the degree of similarity between the registered biometric data and the first data and the second data. According to some example embodiments, the first data may be data that is identical to (e.g., 100% similarity, referred to as a 100% confidence match) or has a high similarity (e.g., between about 97% similarity or confidence match and 100% similarity or confidence match) with registered biometric data. The second data may be another user's data different from the registered biometric data (e.g., a fingerprint image having less than 97% similarity or confidence match with the fingerprint image of the registered biometric data). According to some example embodiments, the similarity determination unit 2211 may search for other similar biometric data by comparing parameters, such as the size, thickness, temperature, and/or humidity of a fingerprint, which is user-specific biometric information. According to some example embodiments, the similarity determination unit 2211 may search for data of which similarity to the registered biometric data is greater than or equal to a first threshold among the first data included in the first group 251 and the data included in the second group 252. The first threshold may be a particular (or, alternatively, predetermined) value or may be data similar to the registered biometric data within a range of upper level of about n percent. n may be a real number greater than or equal to zero. For example, n may be 3, such that the first threshold may be 97% similarity.

The matching degree determination unit 2212 may determine the degree of matching of data (e.g., first data and second data) of which similarity determined by the similarity determination unit 2211 is greater than or equal to a first threshold. When (e.g., in response to a determination, for example by the matching degree determination unit 2212, that) the matching degree is equal to or greater than the second threshold, the matching degree determination unit 2212 may determine that the matching degree is equal to or higher than a reference level and transfer the corresponding data to the learning data matching unit 222. The second threshold may be a particular (or, alternatively, predetermined) value, or may be data corresponding to a range within the upper level of about m percent in the matching degree database. m may be a real number greater than or equal to 0. For example, m may be 3, such that the second threshold may be 97% degree of matching.

The matching degree determination unit 2212 may search for or optimize various related variables to increase the degree of matching when it is determined (e.g., in response to a determination by the matching degree determination unit 2212) that the degree of matching is below the standard (e.g., smaller than the second threshold). According to some example embodiments, the matching degree determination unit 2212 may determine the degree of matching in the matching plane of the first data and the second data. According to some example embodiments, the matching degree determination unit 2212 may determine the matching degree by (e.g., based on) adjusting an angle or a position of the matching plane (e.g., adjusting relative orientations of respective fingerprint images of the first data and the second data). According to some example embodiments, the matching degree determination unit 2212 may determine the degree of matching by adjusting variables such as brightness of the first or second data or humidity of the first or second data.

According to some example embodiments, the degree of similarity is determined based on a first threshold, and the degree of matching is determined based on a second threshold. The first threshold and the second threshold may be values determined considering various variables. According to some example embodiments, the first threshold may be a value determined considering parameters, such as brightness and humidity, and the second threshold may be a value determined considering continuity in the matching plane.

The learning data matching unit 222 may match the learning data by synthesizing the first data with the second data output from the data determination unit 221. Through this, it is possible to generate learning data with a high probability of defending against an attack. This learning data may be biometric spoofing attack data. Referring to the following drawings, a process of generating learning data is described.

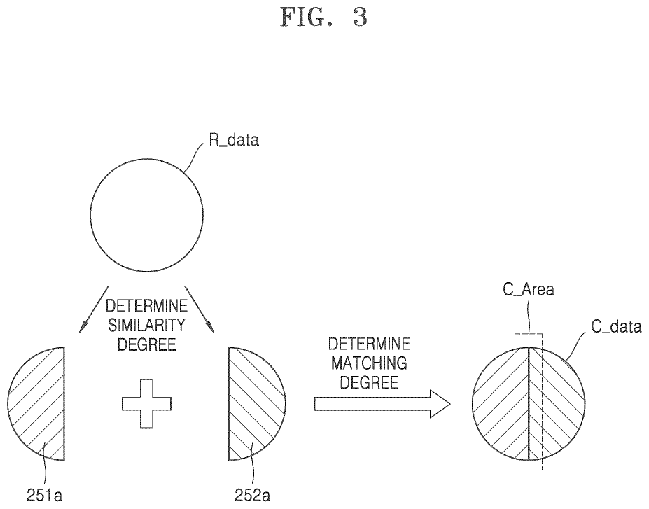

FIG. 3 is a diagram for explaining a process of generating learning data according to some example embodiments.

Circular data R_data shown in FIG. 3 may be registered biometric data. According to some example embodiments, the circular data R_data shown in FIG. 3 may be registered biometric data including complete user fingerprint information and corresponding body information (e.g., physical characteristics, for example temperature data, humidity data, fingerprint image ridge pattern resolution and/or thickness and/or size, etc. associated with a live human body). To show that the data is complete information, the data is shown in the form of a circle.

To attack such circular data R_data, counterfeit data may be generated. According to some example embodiments, the counterfeit data may be generated by matching first data 251a including the user's fingerprint information, that is, information of registered biometric data, but not including body information (e.g., the first data includes non-physical information, for example temperature data, humidity data, fingerprint image pattern resolution and/or ridge thickness, etc. associated with the fingerprint image being generated based on the fingerprint being applied to an input unit by a material that is not included in a live human body, an inorganic material, or the like), and second data 252a not including user's fingerprint information (e.g., including a fingerprint image that does not match the user's fingerprint) but including body information (e.g., the second data includes physical information).

According to some example embodiments, the first data 251a may be data included in the first group 251 of FIG. 2, and the second data 252a may be data included in the second group 252 of FIG. 2.

In this way, when the first data 251a is matched to the second data 252a having different characteristics, matching data C_data may be generated. When the first data 251a and the second data 252a having different characteristics are matched to one another, they may be matched based on the matching plane C_Area. Such matching may include overlapping, superimposing, etc. fingerprint information of the first data 251a with fingerprint information of the second data 252a to generate matching data C-data.

Mismatching may occur in the matching plane C_Area. As mismatching in the matching plane C_Area is reduced, the degree of matching between the first data 251a and the second data 252a may increase. According to some example embodiments, the matching plane C_Area may be a matching plane formed by physical matching, for example an area where the first data 251a and the second data 252a overlap and/or a boundary between the first data 251 and the second data 252a in the matching data C_data. To mitigate mismatching in the matching plane C_Area, a body part having biometric information similar to the stolen biometric information may be required.

In other words, to use a body with similar biometric information for an attack, a method of determining similarity is needed, and an effective attack is possible if an image is created by searching for an image with a high degree of similarity. To defend against an attack on an image having a high matching degree, learning may be performed using image data having a high matching degree.

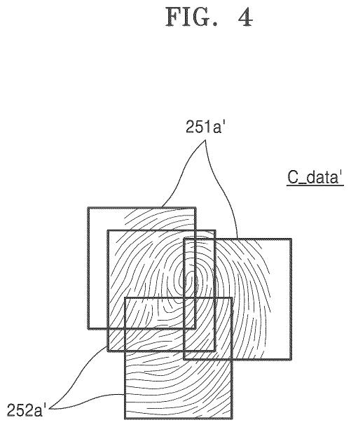

FIG. 4 is some example embodiments of learning data generated according to some example embodiments.

According to some example embodiments, including the example embodiments shown in FIG. 3, two pieces of data 251a and 252a are matched to one another to generate matching data C_data, but three or more pieces of data may be matched to one another to generate matching data.

Referring to FIG. 4, some example embodiments in which four pieces of data (e.g., four separate fingerprint images) are matched to one another (e.g., at least partially superimposed, overlapped, etc.) to generate matching data C_data′ are shown. Referring to FIG. 4, matching data C_data′ formed by matching four pieces of data is shown, which may include for example at least one piece (e.g., instance) of first data 251a′ and at least one piece of second data 252a′, and when three or more pieces of data are matched to each other, the number of matching planes may be further increased, and the match degree determination operation in the matching plane may increase corresponding to the number (e.g., quantity) of matching planes. The matching data C-data′may be considered to be learning data that is generated by a learning data generation unit 120.

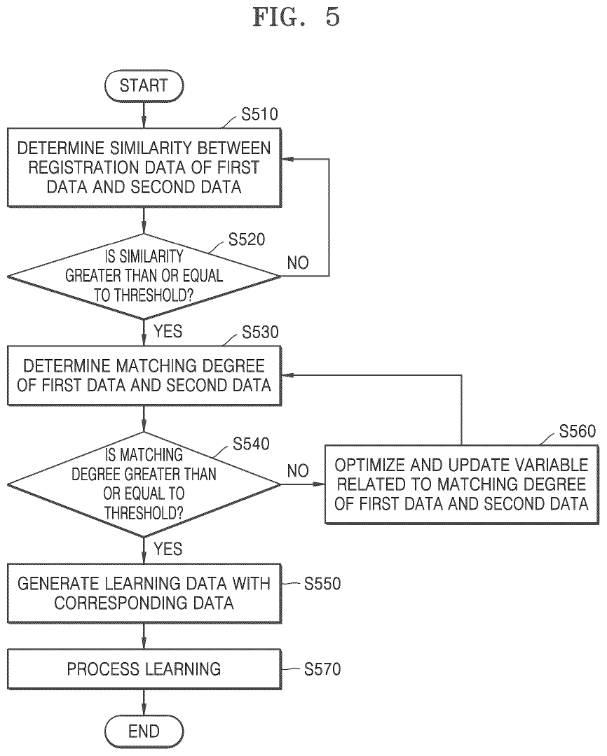

FIG. 5 is a flowchart illustrating a method of generating learning data, according to some example embodiments. Such a method, including any of the operations thereof, may be performed by any device, unit or the like according to any of the example embodiments, including for example the learning data generation unit 120.

In S510, the similarity between the registration data of the first data and the second data may be determined. The first data may be data including fingerprint information of the user but not body information. The second data may be data that does not include the user's fingerprint information but includes body information. According to some example embodiments, the first data and the second data may be data included in the database 150 of FIG. 1. The registration data may mean normal user data including physical information (e.g., temperature data, humidity data, fingerprint pattern resolution and/or ridge thickness, etc.) that is not forged. Registration data may refer to the circular data of FIG. 3.

In S520, it may be determined whether the similarity between the registration data of the first data and the second data is greater than or equal to a threshold (e.g., a first threshold as described herein). At this time, the threshold may be a particular (or, alternatively, predetermined) value or may be a value within the top several percent (e.g., the first threshold may be 97% similarity between the registration data of the first data and the second data). According to some example embodiments, since the first data may include a user's fingerprint information (e.g., an image of the user's fingerprint), the similarity determination with the registration data may be performed with a focus on the second data. When (e.g., in response to a determination) the similarity between the second data and the registration data is less than the threshold, a threshold may be determined by re-selecting second data (e.g., selecting a different second data) having a similarity between the registration data and the second data (e.g., the different second data) that is equal to or greater than the threshold. When the similarity between the second data and the registration data is greater than or equal to the threshold (e.g., S520=YES), a matching degree between the second data and the first data may be determined.

In S530, the degree of matching between the first data and the second data may be determined. In this case, the matching degree may be determined based on a matching plane of the first data and the second data.

In S540, it may be determined whether the degree of matching between the first data and the second data is greater than or equal to a threshold (e.g., a second threshold as described herein). At this time, the threshold may be a particular (or, alternatively, predetermined) value or may be a value within the top several percent (e.g., the second threshold may be 97% matching between the first data and the second data). When (e.g., in response to a determination) the degree of matching between the first data and the second data is greater than or equal to the threshold (e.g., S540=YES), the first data and the second data may correspond to data satisfying both the similarity condition and the matching condition.

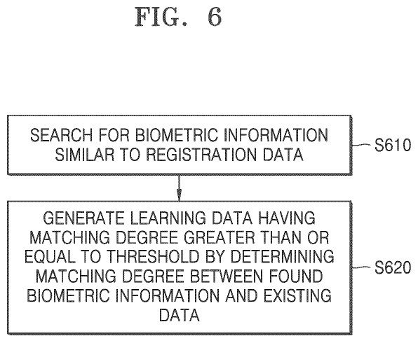

In S550, learning data may be generated by matching the corresponding first data and second data that were determined at S540 to correspond to data satisfying both the similarity condition and the matching condition. This is described in detail with regard to some example embodiments with reference to FIG. 6.

In S570, learning processing may be performed using the generated learning data. Through this, the performance of the counterfeit detection system may be increased.

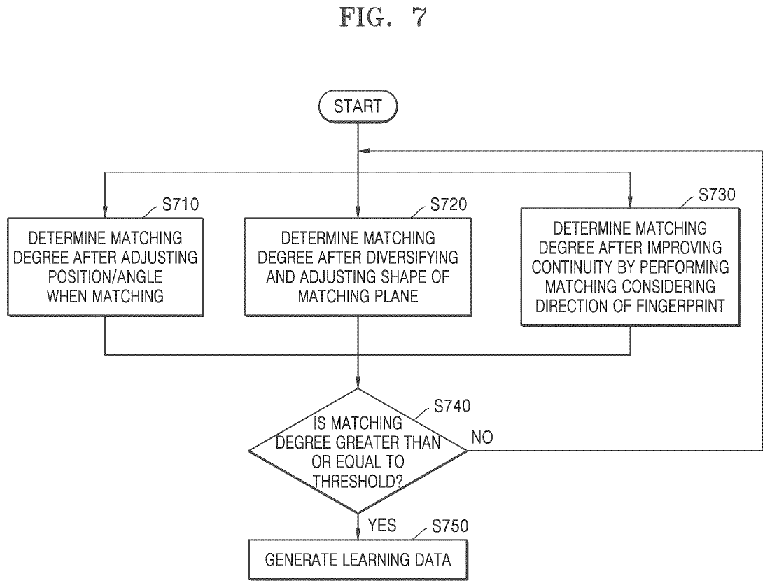

In S560, if the matching degree is less than the threshold, also referred to herein as the second threshold (e.g., S540=NO), to make the matching degree more than the threshold, a variable related to the degree of matching between the first data and the second data may be optimized (e.g., adjusted) and updated. This is described in detail with reference to FIG. 7.

According to some example embodiments, when an existing registered database exists, the method shown in FIG. 5 may include selecting first data and second data from a corresponding database, first determining the degree of similarity, and then determining the degree of matching.

FIG. 6 is a flowchart illustrating a method of generating learning data, according to some example embodiments.

In S610, biometric information similar to registration data may be searched for. According to some example embodiments, registration data may correspond to circular data of FIG. 3. According to some example embodiments, a difference from S510 of FIG. 5 may be that similar biometric information may be searched for in the entire database that includes both the first data and the second data. According to some example embodiments, as in S510 of FIG. 5, similarity may be determined in a state in which the database is divided into a first data group and a second data group, and as in S610 of FIG. 6, similar biometric information may be searched for throughout the database.

In S620, it is possible to determine the degree of matching between the biometric information retrieved in S610 and existing data, that includes registration data information. By determining the degree of matching, it is possible to generate learning data having a degree of matching equal to or greater than a threshold.

FIG. 7 is a flowchart illustrating a matching degree determination method according to some example embodiments.

Referring to FIG. 7, each of S710, S720, and S730 shows examples in which a matching degree may be re-determined by adjusting variables related to data matching when it is determined that the matching degree is below the threshold in S740.

According to S710, when matching the first data to the second data, a matching degree may be determined by adjusting a position or an angle (e.g., a relative position or a relative angle of respective images of the first data and the second data at least partially overlapped with each other). According to some example embodiments, an image having high continuity of a fingerprint may be synthesized by adjusting a location and an angle when performing physical matching of the first data to the second data, and a matching degree may be increased.

According to S720, after diversifying and adjusting the shape of the matching plane of the first data and the second data, a matching degree may be determined. According to some example embodiments, images may be synthesized by diversifying the shape of the matching plane of the first data and the second data into a straight line or a curved shape.

According to S730, continuity may be improved by performing matching considering the direction of the fingerprint. After that, the matching degree may be determined. According to some example embodiments, synthesis with improved continuity may be performed by generating a matching plane according to a direction of a fingerprint.

Through S710, S720, and S730, it is possible to generate data having a natural boundary surface of the matching plane, that is, data in which mismatching is mitigated. Data with reduced mismatching may refer to data in which a boundary is naturally connected by adjusting the position, angle, brightness, humidity, and the like.

In S740, if it is determined that the matching degree is equal to or greater than the threshold, learning data may be generated in S750.

According to the inventive concepts, a synthesized image having a high matching degree may be generated through various methods and used for learning.

According to the flowcharts shown in FIGS. 5 to 7, some example embodiments of determining a matching degree after first determining a degree of similarity is shown, but the inventive concepts may not be limited thereto. According to the inventive concepts, the degree of similarity may be determined after determining the matching degree first.

In addition, according to the flowcharts shown in FIGS. 5 to 7, some example embodiments of generating only one piece of learning data is shown, but it is natural that a plurality of pieces of learning data may be generated by repeating the sequence of FIGS. 5 to 7.

In some example embodiments, including the example embodiments shown in FIGS. 5 to 7, only cases in which the first data is identical to registered biometric data are shown, but it should be noted that the first data may be applied even when the first data is similar to registered biometric data and includes non-physical information.

To increase the attack success rate using forged data, other biometric information with a high matching degree similar to the forged information made from stolen biometric information is required. The learning data generation method according to the inventive concepts may determine the similarity and matching degree to identify biometric information having a high matching degree and a high similarity to stolen biometric information among a large amount of biometric information secured for an attack. According to some example embodiments, a matching degree may be identified by identifying a mismatched part, that is, information of a matching plane, and similarity may be determined by information of other parts.

According to some example embodiments, to achieve matching with a high degree of similarity and matching degree, various conditions, such as angle, position, brightness, and humidity of matching, must be satisfied. According to the inventive concepts, variables, such as angle, location, brightness, and humidity of matching, may be optimized, similarity and matching degree may be identified, and variables may be searched for to maximize similarity and matching degree. The similarity and matching degree are re-determined among the matched data results using the found variables, and the image may be saved by selecting data having a high matching degree.

If images with high similarity and high matching degree are accumulated as data among images with mismatching determined in this way, it is possible to secure fake attack image data with high attack efficiency, and this may be used for the development of conventional algorithms and for learning a CNN to improve the performance of counterfeit detection systems.

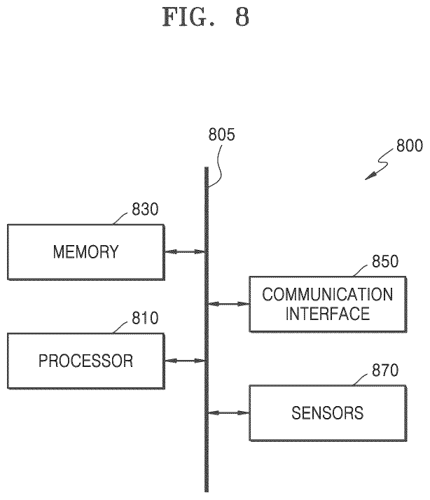

FIG. 8 is a block diagram of a learning data generation system according to some example embodiments.

Referring to FIG. 8, a learning data generation system 800 according to some example embodiments includes a processor 810. The learning data generation system 800 may include a memory 830, a communication interface 850, and sensors 870. The processor 810, the memory 830, the communication interface 850, and the sensors 870 may communicate with each other via a communication bus 805.

To check whether the input biometric information is falsified, the processor 810 may determine the similarity between the data and registered biometric information, generate matching data having a high attack level by determining a matching degree between a plurality of pieces of data together, and determine whether the input biometric information is forged by performing learning using the matching data generated in this way.

The processor 810 may perform data learning using a neural network trained to extract features suitable for detecting whether biometric information is forged or not.

The memory 830 may include a database for storing registered biometric information and/or counterfeit biometric information. The memory 830 may store pre-learned parameters of the neural network. The sensors 870 are devices that sense the user's biometric information, and may include, for example, a fingerprint sensor that senses the user's fingerprint.

In addition, the processor 810 may perform the method described above with reference to FIGS. 5 to 7. The processor 810 may execute a program and control the learning data generation system 800. Program code executed by the processor 810 may be stored in the memory 830. The learning data generation system 800 may be connected to an external device (e.g., a personal computer or network) through an input/output device (not shown) and exchange data. The learning data generation system 800 may be installed in various computing devices and/or systems, such as smartphones, tablet computers, laptop computers, desktop computers, televisions, wearable devices, security systems, and smart home systems.

Some example embodiments described above may be implemented as hardware components, software components, and/or a combination of hardware components and software components. For example, the devices, unit, systems, methods, and components described in some example embodiments (e.g., the counterfeit detection system 100, the input unit 110, the learning data generation unit 120, the learning unit 130, the determination unit 140, the database 150, the learning data generation system 200, the first group 251, the second group 252, the data determination unit 221, the learning data matching unit 222, the learning data generation system 800, the processor 810, the memory 830, the communication interface 850, the sensors 870, any operation of any of the methods shown in FIGS. 5 to 7, any portion thereof, or the like) may include, may be included in, may be implemented by, and/or may be implemented using a processing device which may include one or more general purpose computers or special purpose computers, for example, a processor, a controller, an arithmetic logic unit (ALU), a digital signal processor, a microcomputer, a field programmable gate array (FPGA), a programmable logic unit (PLU), a microprocessor, or any other device capable of executing and responding to instructions to implement any of the operations of any of the methods according to any of the example embodiments, implement the functionality of any of the units, systems, devices, or the like according to any of the example embodiments, or the like. The processing device may include a processor (e.g., a CPU) configured to execute a program stored on a memory (e.g., a solid state drive, or SSD, memory device) to execute an operating system (OS) and software applications running on the OS to implement any of the operations of any of the methods according to any of the example embodiments, implement the functionality of any of the units, systems, devices, or the like according to any of the example embodiments, or the like. In addition, the one or more processing devices may access, store, operate, process, and generate data in response to the execution of software (e.g., in response to executing a program of instructions stored at a memory) to implement any of the operations of any of the methods according to any of the example embodiments, implement the functionality of any of the units, systems, devices, or the like according to any of the example embodiments, or the like. For the convenience of understanding, in some cases, one processing device may be described as being used, but those of ordinary skill in the art will appreciate that the processing device may include a plurality of processing elements (also referred to herein interchangeably as processing devices) and/or multiple types of processing elements. For example, the processing device may include a plurality of processors or one processor and one controller. In addition, other processing configurations are possible, such as a parallel processor.

The software may include a computer program, code, instructions, or a combination thereof, and may configure the processing device to operate as desired, or may command the processing device independently or collectively. To be interpreted by the processing device or to provide commands or data to the processing device, software and/or data may be permanently or temporarily embodied in any type of machine, component, physical device, virtual equipment, computer storage medium or device, or signal wave to be transmitted. The software may be distributed over networked computer systems and stored or executed in a distributed manner. Software and data may be stored on computer-readable recording media.

The method according to some example embodiments may be implemented in the form of program instructions that may be executed through various computer means (e.g., one or more processing devices as described herein) and recorded in a computer-readable medium. The computer-readable medium may include program instructions, data files, data structures, etc. alone or in combination. The program instructions stored in the computer-readable medium may be specially designed and configured for some example embodiments, or may be known and usable to those skilled in computer software. Examples of computer-readable recording media include hardware devices specially configured to store and execute program instructions, for example, magnetic media such as hard disks, floppy disks and magnetic tapes, optical media such as CD-ROMs and DVDs, magneto-optical media such as floptical disks, and ROM, RAM, flash memory, etc. Examples of the program instructions include not only machine language code such as those produced by a compiler, but also high-level language code that may be executed by a computer (e.g., one or more processing devices as described herein) using an interpreter or the like.

While the inventive concepts have been particularly shown and described with reference to some example embodiments thereof, it will be understood that various changes in form and details may be made therein without departing from the spirit and scope of the following claims.

What is claimed is:

1. A learning data generation method, comprising:
selecting first data and second data, each of the first data and the second data having a similarity to registered biometric data that is greater than or equal to a first threshold;
determining a matching degree between the first data and the second data; and
generating learning data based on matching the first data to the second data in response to a determination that the matching degree is greater than or equal to a second threshold.

2. The learning data generation method of claim 1, wherein
the first data comprises data including non-physical characteristics, and
the second data comprises data including physical characteristics.

3. The learning data generation method of claim 1, wherein
the first data comprises data including a part identical to the registered biometric data, and
the second data comprises data that does not match the registered biometric data.

4. The learning data generation method of claim 1, wherein the determining of the matching degree between the first data and the second data comprises:
searching for a variable having a maximum matching degree between the first data and the second data; and
determining a matching degree between the first data and the second data to which the variable having the maximum matching degree is applied.

5. The learning data generation method of claim 4, wherein the variable having the maximum matching degree comprises at least one of a matching angle, a matching position, brightness of the first data or the second data, or humidity of the first data or the second data.

6. The learning data generation method of claim 4, wherein the determining of the matching degree between the first data and the second data is based on a matching plane between the first data and the second data.

7. A counterfeit detection system, comprising:
a learning data generation unit configured to generate learning data obtained based on matching first data and second data;
a learning unit configured to learn content through the learning data generated by the learning data generation unit;
an input unit configured to receive biometric data; and
a determination unit configured to determine whether the biometric data is normal data or forged data based on the content learned in the learning unit,
wherein the learning data includes data indicating a similarity degree with the normal data and a matching degree between the first data and the second data.

8. The counterfeit detection system of claim 7, wherein
the first data comprises data in which biometric information and non-physical information including a same part as the normal data are mixed, and
the second data comprises data in which biometric information different from the normal data and body information are mixed.

9. The counterfeit detection system of claim 8, wherein the non-physical information comprises material information indicating materials providing the biometric information of the first data, wherein the materials providing the biometric information of the first data are different from materials providing the biometric information of the normal data.

10. The counterfeit detection system of claim 8, wherein the learning data generation unit is configured to
select, from the data in which biometric information different from the normal data and body information are mixed, a particular data that is determined to be similar to the normal data, and
determine the selected data as the second data.

11. The counterfeit detection system of claim 10, wherein the learning data generation unit is configured to
determine the matching degree between the first data and the second data, and
generate data having a matching degree equal to or greater than a threshold value as the learning data.

12. The counterfeit detection system of claim 11, wherein the determination of the matching degree determines the matching degree in a matching plane of the first data and the second data.

13. The counterfeit detection system of claim 11, wherein the learning data generation unit is configured to
search for a variable in which a matching degree between the first data and the second data is maximized as a variable having a maximum matching degree, and
re-determine the matching degree between the first data and the second data to which the variable having the maximum matching degree is applied, to generate the data having the matching degree equal to or greater than the threshold value as the learning data.

14. The counterfeit detection system of claim 13, wherein the variable having the maximum matching degree comprises at least one of a matching angle, a matching position, brightness of the first data or the second data, or humidity of the first data or the second data.

15. A system for generating learning data for learning counterfeit data for attacking registered biometric data, the system comprising:
at least one database including
a first group including information of the registered biometric data but not body information;
a second group including body information and not including information of the registered biometric data; and
a learning data matching unit configured to generate the learning data based on matching at least one piece of data from the first group to at least one piece of data from the second group.

16. The system of claim 15, further comprising:
a similarity determination unit configured to determine similarities between
first data that is included in the first group and second data that is included in the second group, and
the registered biometric data; and
a matching degree determination unit configured to determine a matching degree between the first data and the second data.

17. The system of claim 16, wherein the learning data matching unit is configured to generate the learning data based on matching the first data and the second data in response to a determination that
the first data and the second data each satisfy a similarity greater than a first threshold, and
the matching degree between the first data and the second data is greater than a second threshold.

18. The system of claim 17, wherein the matching degree determination unit is configured to determine a matching degree in a matching plane of the first data and the second data.

19. The system of claim 17, wherein the matching degree determination unit is configured to
search for a variable having a maximum matching degree between the first data and the second data, and
adjust a value of the variable to select the first data and the second data having the maximum matching degree.

20. The system of claim 19, wherein the variable having the maximum matching degree comprises at least one of a matching angle, a matching position, brightness of the first data or the second data, or humidity of the first data or the second data.
